(19) United States
(12) Patent Application Publication
(10) Pub. No.: US 2005/0165647 A1
(43) Pub. Date: Jul. 28, 2005

(54) Retail network for supporting product ordering

(76) Inventor: Sergey N. Razumov, Moscow (RU)

Correspondence Address: McDERMOTT, WILL & EMERY, 600 13th Street, N.W., Washington, DC, 20005-3096, US

(21) Appl. No.: 10/762,339

(22) Filed: Jan. 23, 2004

(51) Int. Cl. G06F 17/60

(52) U.S. Cl. 705/26

(57) ABSTRACT

The present application offers a novel retail network that comprises at least one district network for providing retail operations within a district. The district network includes multiple regional networks for providing retail operations within respective regions of the district, and at least one district distribution node for providing transfer of goods to the regional networks. Each of the regional networks includes multiple points of sales and a regional distribution node responsive to customers' orders for supplying the ordered goods to the points of sales, which may include stationary points of sale and mobile points of sale. A point of sale may include a section for enabling customers to pick up the ordered goods delivered from the respective regional node, and a section for selling merchandise available in stock.

### FIELD OF THE INVENTION

The present invention relates to retail management, and more particularly, to a retail network that enables customers to order and pick up a wide assortment of goods.

### BACKGROUND OF THE INVENTION

It is well known that the most expensive place to hold merchandise is on the shelf of a retail store because of all resources it consumes until that point, such as labor, transportation, and storage costs. To reduce these costs, retailers are forced to limit assortment of products that they offer.

However, limited assortment results in lost sales and inconvenience for customers. Consumer study conducted by Accenture and the Food Marketing Institute (FMI) showed that of the products consumers want in a grocery store, 6% to 8% are out-of-stock. For promotional items, this number jumps to 25% out-of-stock products. The study concluded that the out-of-stock levels add up to about $100 billion in lost sales for retailers.

Internet stores allow retailers to reduce merchandising costs. However, these stores do not enable customers to quickly and reliably obtain ordered goods. In addition, customers are not able to quickly return an undesired product and receive a refund. Instead, they have to repackage an undesired product and send it by mail to a vendor.

Therefore, there is a long-felt need for a new retail model that would provide advantages of Internet stores but offer quick and reliable delivery of a wide assortment of goods to a point of sale selected by a customer.

### SUMMARY OF THE INVENTION

One advantage of the present invention is in providing a retail network that guarantees quick and reliable delivery of goods ordered by a customer to any point of sale selected by the customer, and enables the customer to return a delivered item to any selected point of sale and receive an immediate refund.

Another advantage of the present invention is in providing a retail network that offers to a customer a practically unlimited assortment of goods including products available in geographical regions outside of a customer's home region.

A further advantage of the present invention is in providing a retail network that makes it possible to substantially reduce price of goods due to reduced cost of retail operations.

Another advantage of the present invention is in providing a retail network that enable retailers to meet customers' demand without having to stock retail stores with excessive amount of products.

Another advantage of the present invention is in providing a retail network using substantially reduced retail space.

A further advantage of the present invention is in providing a retail network that makes it possible to reduce cost of merchandise transportation.

Another advantage of the present invention is in providing a customer with ability to select a place of ordering and a method of ordering.

These and other advantages of the present invention may be achieved at least in part by a retail network that comprises at least one district network for providing retail operations within a geographic area hereinafter referred to as a transport district. The district network includes multiple regional networks for providing retail operations within respective regions of the transport district, and at least one district distribution node for providing transfer of goods to the regional networks. Each of the regional networks includes multiple points of sales, which may include stationary points of sale and mobile points of sale, and a regional distribution node responsive to customer's orders for supplying the ordered goods to the points of sales. A point of sale may include a section for enabling customers to pick up the ordered goods delivered from the respective regional node, and a section for selling merchandise available in stock. Each node of the network may include a warehouse or other storage facility for storing products and materials.

In accordance with one aspect of the invention, at least one specialty node may be arranged in the network for providing operations with a particular type of merchandise. The district distribution node may provide transfer of goods between the specialty node and the regional networks.

In accordance with another aspect of the invention, two-directional transfer of goods may be provided between a regional node and points of sale in the respective regional network, and between various nodes of the network. For example, a district node may be configured for supplying goods to respective regional nodes, and for receiving goods from the regional nodes.

In accordance with a further aspect of the invention, the goods transferred via the district node may include a retail stream of goods representing merchandise ordered by the customers and a wholesale stream of goods representing merchandise transferred to the regional distribution node to replenish stocks. The retail stream may be assigned with priority higher than priority of the wholesale stream.

In accordance with another aspect of the invention, different mechanisms may be engaged at the district distribution node for handling the wholesale stream of goods and products ordered by customers. A routing mechanism may be used for routing the wholesale stream transferred from the specialty node in accordance with a destination address identifying the regional distribution node. By contrast, a repackaging mechanism may be provided for removing goods ordered by a customer from a container packaged at the specialty node and packaging the goods into a container addressed to the respective regional network.

In accordance with a further aspect of the invention, the regional distribution node is configured for being supplied with merchandise purchased from a vendor located within a respective region. Via the respective district node, the purchased merchandise may be transferred from the regional node to other nodes of the retail network.

In accordance with another aspect of the invention, a gateway mechanism may be arranged for providing transfer of goods between the district networks.

In accordance with a further aspect of the invention, a system for processing orders is offered. The orders may be received from a client terminal, such as a computer terminal installed at a point of sales or at any point of ordering arranged conveniently for customers, a customer's personal computer or digital device, and a telephone set for entering voice commands identifying ordered goods and selected points of sale. The client terminal enables the customer to send a request providing indication of an item being purchased and indication of a point of sale selected for delivery of the item. Also, the request may identify a purchaser, i.e. a person that places the order. The system may comprise a server associated with a selected node of the retail network located outside a regional network having the point of sale selected for delivery. The server is configured for receiving the request if the item is not available in the regional network, and for arranging a delivery path for delivery the item from the selected node to the selected point of sale.

In accordance with another aspect of the invention, the server may route the delivery path from the selected node to the selected point of sale via respective regional and district nodes. Also, the server may schedule delivery of the item from the selected node to the district node, from the district node to the regional node, and from the regional node to the selected point of sale.

In accordance with a further aspect of the invention, a server in the network may arrange a return path for returning an item delivered to a customer if the customer is not satisfied with the delivered item. The return path may be arranged from any point of sale selected by the customer to the node, from which the item was delivered. The return path may be routed via the respective regional and district nodes.

In accordance with another aspect of the invention, the regional node may be supplied with merchandise purchased from a vendor in a region covered by the respective regional retail network. The regional node may be controlled to arrange a purchased merchandise path from the regional node to any node in the network selected for delivery of the purchased merchandise. The purchased merchandise path may be routed via the respective district node.

In accordance with a further aspect of the invention, in a system for processing orders, a server may be configured for receiving the customer's request and enabling the customer to locate a retail network node at which the requested item is available. This node may be arranged outside a local retail network corresponding to the point of sale selected for delivery.

Still other aspects and advantages of the present invention will become readily apparent from the following detailed description, simply by way of illustration of the best mode contemplated of carrying out the invention. As will be realized, the invention is capable of other and different embodiments, and its several details are capable of modifications in various obvious respects, all without departing from the invention. Accordingly, the drawing and description are to be regarded as illustrative in nature, and not as restrictive.

### BRIEF DESCRIPTION OF THE DRAWINGS

FIG. 1 illustrates a retail network of the present invention.

FIG. 2 illustrates a regional retail network RRN shown in FIG. 1.

FIG. 3 shows a multi-layer reference model presenting functions and operations of the retail network.

### DETAILED DESCRIPTION OF THE INVENTION

In the following description, for the purposes of explanation, numerous specific details are set forth in order to provide a thorough understanding of the present invention. It will be apparent, however, to one skilled in the art that the present invention may be practiced without these specific details. In other instances, well-known structures and entities are shown in a block diagram form in order to avoid unnecessarily obscuring the present invention.

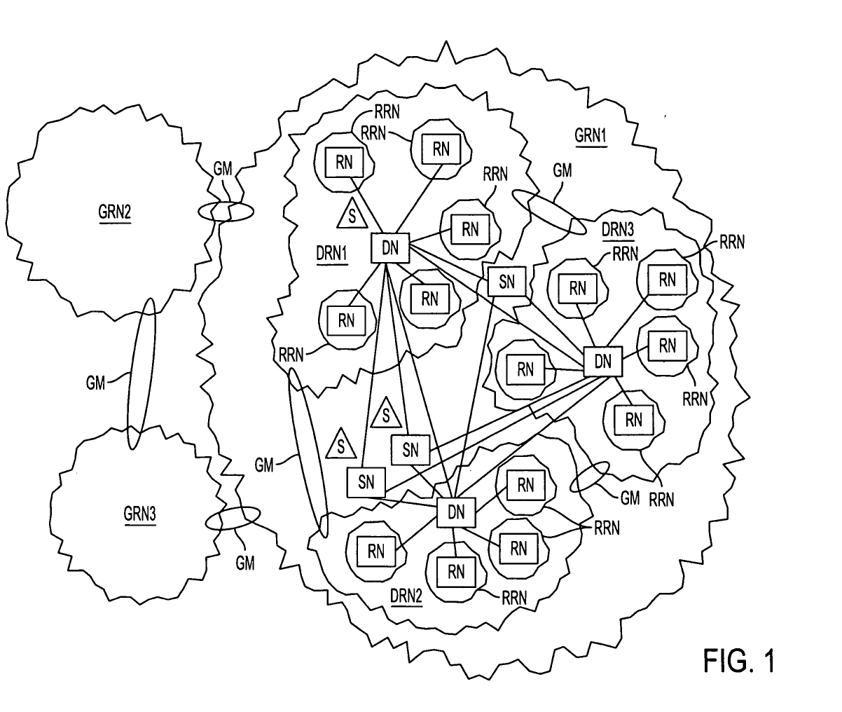

Referring to FIG. 1, a retail network of the present invention has a hierarchical arrangement that may include at least one global retail network GRN at a top hierarchical level. For example, FIG. 1 shows global retail networks GRN1, GRN2, GRN3 that may cover the North American, European and Asian continents, respectively.

A territory covered by each global retail network may include multiple transport districts. Each transport district may correspond to a particular geographic area, a country or an administrative district. Each global retail network may comprise at least one district retail network (DRN) covering the respective transport district. For example, FIG. 1 shows that global retail network GRN 1 includes district retail networks DRN1, DRN2 and DRN3.

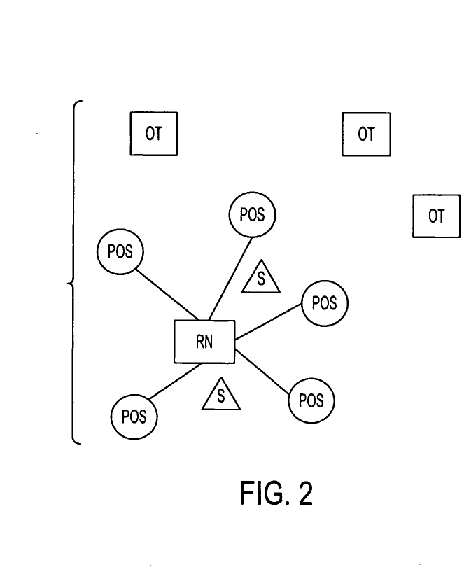

Each district retail network DRN includes at least one district distribution node (DN) and multiple regional retail networks (RRN) covering respective regions within a transport district. A district distribution node includes a storage facility or warehouse for temporarily storing goods to be transferred to the regional retail networks. As shown in FIG. 2, a regional retail network RRN may include a regional node (RN) and multiple points of sale (POS). A point of sale may be a stationary or mobile retail facility, such as a store; or any place, such as a place of residence or business, selected by a customer to receive an ordered product. A point of sale may include an order pick-up section for enabling a customer to pick up goods ordered in advance, and a retail section for selling a limited number of items available for purchasing without ordering in advance. A regional node RN includes a storage facility or warehouse for storing merchandise, including goods to be delivered to points of sale.

Further, the global retail network (GRN) may include at least one specialty node (SN) for selling a particular type of goods. For example, the GRN may have specialty nodes for selling automotive parts and accessories, appliances, construction materials, clothing, footwear, furniture, food products, computers and consumer electronics, books, audio and video products, home and garden products, children's goods, sports products, beauty products, pets products, etc. Each specialty node may have a warehouse or other storage facility for storing the respective type of goods. As discussed in more detail later, each specialty node provides transfer of goods to a point of sale selected by a customer via the respective regional node and district distribution node. The regional and district nodes may supply the specialty nodes with goods purchased from vendors in areas covered by the respective regional and district networks.

The retail network of the present invention is associated with multiple ordering terminals OT (FIG. 2) for enabling customers to order goods. The ordering terminals may include computer terminals installed at points of sales or at various points of ordering arranged conveniently for customers, for example, at community centers, office buildings, industrial facilities, post offices, parking lots, etc. Also, the ordering terminals may include customers' personal computers, such as desktop and laptop computers, or other personal digital devices, such as personal digital assistants or cell phone, connectable to a telecommunication system of the retail network via telecommunications links. Further, the ordering terminals may include telephone sets, including telephone sets at customer's home or place of business, that enable customers to place an order using voice commands.

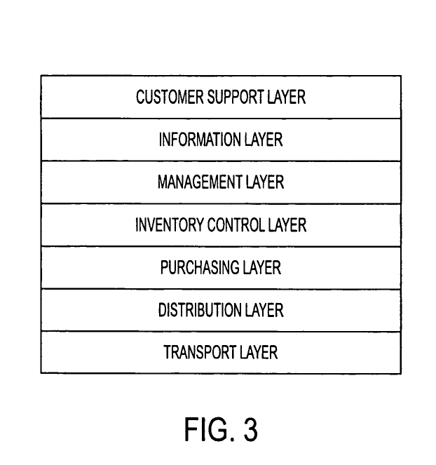

To present functions and protocols performed by the retail network of the present invention, a multi-layer reference model is utilized. As illustrated in FIG. 3, the reference model presents a layered approach to operations performed by the retail network from the top layer relating to customer support operations to the bottom layer relating to physical transfer of goods. For the purposes of explanation, the reference model utilized in the present application includes seven layers. However, one skilled in the art will understand that the present invention may be practiced without some of the presented layers. Also, some additional layers may be introduced to present further functions and protocols.

The multi-layer reference model presenting the retail network of the present invention may include from the top to the bottom the following layers: the Customer Support layer, the Information layer, the Management layer, the Inventory Control layer, the Purchasing layer, the Distribution layer, and the Transport layer. The Customer support layer, which may be the top layer of the multi-layer reference model, may include customer support operations, for example, relating to enabling customers to place orders for goods and pick up delivered goods. The next layer may be the Information layer that includes operations performed to provide informational support for retail operations, for example, providing customers with information relevant to ordering goods and their delivery to a selected point of sale. The Management layer may include management operations relating to product pricing, marketing, forming assortment, merchandising, etc. The Inventory Control layer may relate to inventory control operations. The Purchasing layer may include operations relating to purchasing goods from wholesalers, manufacturers and other vendors for future sale to customers. The Distribution layer may include operations performed at district, regional, and special nodes and points of sales in connection with distribution of goods being transferred from a source to a destination. Finally, the Transport layer on the bottom of the structure may include operations relating to physical transfer of goods from a source to a destination.

As shown in FIGS. 1 and 2, multiple servers S may be arranged at various points of the retail network to perform functions and operations at the layers described above. For examples, servers may be associated with district nodes DN, regional nodes RN, specialty nodes SN and various points of sale. A particular function may be assigned to different servers depending on available computer capacities. Also, some functions may be distributed among several servers to reduce bandwidth consumption.

An ordering terminal enables a customer to place an order for a required item and select a point of sale for delivery of this item. The ordering terminals may include, without limitation, computer terminals installed at points of sales or at various points of ordering arranged conveniently for customers, customers' personal computers or digital devices, such as a personal digital assistant (PDA) or a cell phone with Internet access, and telephone sets for entering voice commands identifying the customer, ordered goods and a selected point of sale.

Via a telecommunication system, such as the Internet or private lines dedicated to a customer's use, the ordering terminal provides customer's access to an order support server, which performs an ordering protocol at the Customer Support and Information Levels to provide the customer with ability to select and order required goods. An exemplary ordering protocol is described in more detail in my copending U.S. patent application Ser. No. 10/354,025 filed on Jan. 30, 2003 and incorporated herewith by reference. Functions of an order support server may be carried out by a computer associated with a point of sale, a regional node or a district node. Alternatively, the order support functions may be distributed among several computers arranged in various points of the retail network. For instance, to reduce traffic in telecommunications lines, a computer associated with a point of sale may provide a customer with information that requires a wide bandwidth, such as multimedia information relating to the ordering protocol, whereas a computer associated with a regional node or a district node may provide the customer with information requiring a narrow bandwidth, such as pricing information.

The order support server may cause the ordering terminal to produce a graphical user interface that displays goods available in stock at a node of a regional network corresponding to a point of sale selected by the customer for delivery of ordered goods. If the required item is in stock at the regional node, the graphical user interface enables the customer to place an order for delivery the required item from the regional node to a selected point of sale. A call center may be provided to enable a customer to place an order using a telephone set. A server associated with the regional node arranges delivery of the requested item from the regional node to the selected point of sale.

If the required item is not available in the regional node's stock, the order support server may locate another node, such as a specialty node, at which the required item is available. For example, an ordering protocol for ordering an item which is not available at the regional node may be performed using a search function of the graphical user interface. When a customer performs a search for a required item, the order support server may identify another node, such as a specialty node, at which the required item is available, and enable the customer to place an order for delivery the required product from this node to a selected point of sale.

Via a telecommunication system, such as the Internet or private telecommunications lines, the order is transferred to a node server associated with the selected node, at which the item is available, for example, a specialty node SN. In response to the order, the node server performs a routing protocol at the Transport and Distribution layers for arranging a path for delivery the required item from the specialty node to the selected point of sale. The delivery path includes a link from the specialty node to a district node of a district retail network, which includes the regional network having the point of sale selected by the customer, and a link from the district node to the regional node of the respective regional network. From the regional node, the requested item is delivered to the selected point of sale.

The routing protocol involves scheduling deliveries from the specialty node to the district node, from the district node to the regional node and from the regional node to the selected point of sale. The routing protocol may set a timetable for delivery from one point of the network to another. Each item transferred via the retail network of the present invention may be assigned with a source address corresponding to a point, from which it is being delivered, and a destination address corresponding to a destination point. A server associated with each intermediate node in the network may replace the destination address assigned to the item at the originating node with the destination address of the next point in the delivery path. Hence, goods may be routed from any source to any destination via designated intermediate nodes. The routing protocol may include producing a chain of addresses for delivery an item from a source to a destination.

A server associated with the point of sale may perform a product pick-up protocol performed at the Customer Support and Information Levels to enable a customer to quickly pick up the ordered product. The product pick-up protocol is disclosed in more detail in my copending U.S. patent application Ser. No. 09/788,674 filed on Feb. 21, 2001 and incorporated herewith by reference. For example, the product pick-up protocol may include automatic assignment of a pick-up section to a customer, when she arrives to pick up the requested product.

If a customer is not satisfied with the delivered item, she is enabled to return it at a selected point of sale and receive an immediate refund. A server associated with the node of the regional network, that includes the selected point of sale, performs a routing protocol at the Transport and Distribution layers to arrange a path for delivery of the return item back to the specialty node. The delivery path for returning an undesired item includes links from the selected point of sale to the regional node, from the regional node to the district node and from the district node to the specialty node. The routing protocol for returning an undesired item includes scheduling delivery from the point of sale to the regional node, from the regional node to the district node and from the district node to the specialty node.

Each district and regional network may perform a purchasing protocol at the Purchasing level to purchase goods from wholesalers, manufacturers and other vendors in the area covered by the respective district or regional network. A server of the respective district or regional network may perform a routing protocol at the Transport and Distribution layers to arrange a path for transferring the purchased goods. This path may be originated from a regional node for transferring the purchased goods via the respective district node to a specialty node. Alternatively, the path originated at the regional node may provide transfer of the purchased goods via the respective district node to another regional node. The path for transferring purchased goods originated at the district node may provide transfer of the purchased goods to a specialty node. Alternatively, this path may provide transfer of the purchased goods to a regional node in the respective district network.

Each district network may contain a gateway mechanism GM (FIG. 1) for performing a gateway protocol to transfer goods between district networks. Also, gateway mechanisms may be arranged for transferring goods between global networks.

As discussed above, each regional node may maintain a stock of goods for sale to customers at points of sale of the respective regional network. For example, this stock may include food products and consumer goods that are frequently ordered by customers of the respective regional network. In addition, the points of sale may include retail stores having a retail section for selling a limited number of popular items available for purchasing without ordering in advance. The stock of a regional node may be utilized to replenish stocks of the retail stores in the respective regional network. The retail network of the present invention performs a stock control protocol at the Inventory Control layer to control and maintain the right amount of each item in stocks of the regional nodes and the retail stores.

Stock of a regional node may be replenished by: 1) goods purchased from wholesalers, manufacturers and other vendors in the area covered by the respective regional network; 2) goods purchased from wholesalers, manufacturers and other vendors in areas covered by other regional networks and transferred via respective district nodes; and 3) goods supplied from specialty nodes via respective district nodes. A server associated with the regional node may request delivery of stock-replenishing items from the respective source. In response to this request, a server associated with the respective source arranges a path for transfer of stock-replenishing items from the source to the requesting regional node, via respective district nodes. A routing protocol for transferring stock-replenishing items may include setting time tables for scheduling transfer of these items from one network's node to another.

Hence, a district node may simultaneously perform the transfer of goods ordered by customers, and the transfer of stock-replenishing items ordered to replenish stocks of regional nodes. An associated transfer control server may control the district node to perform operations required to provide the both types of transfer. The district node may be controlled to reassemble a stream of customers' ordered goods incoming from a specialty node or another district node, in order to form multiple streams directed to different regional nodes in the respective district network. For example, the goods ordered by customers may be carried in containers. The ordered goods received at the district node from a specialty node or another district node may be removed from a container, that carried them to the district node, and placed in different containers to be transferred to different regional nodes. As a result, the flexibility of routing increases.

By contrast, the stock-replenishing items may be carried on pallets, without reassembling at a district node. Instead, a routing protocol may be performed by a server associated with the district node to assign an incoming pallet with a destination address corresponding to the respective regional node. To expedite delivery of goods ordered by customers, streams of these goods are assigned with higher priority than streams of stock-replenishing items.

Also, a district node may have a buffer mechanism for buffering selected items before delivery to regional nodes. For example, seasonal goods may be subject to buffering at district nodes. A server associated with the district node may perform a buffering protocol at the Inventory Control layer to schedule and control buffering of selected items.

As discussed above, the retail network of the present invention carries two-directional streams of goods. For example, a district node handles streams of customers' ordered products and stock-replenishing items in the direction of a respective regional node. Streams of goods returned by customers and goods purchased from local vendors are transferred in the opposite direction from the respective regional node to the district node. As a result, the cost of transportation may be substantially reduced.

A networking approach utilized in the present invention provides customers with ability to conveniently order goods of a practically unlimited assortment available in any geographical area covered by one of multiple regional networks. Moreover, due to protocols performed to transfer goods via the retail network, customers are enabled to quickly and reliably pick up the ordered goods at any selected point of sale. In addition, if a customer is not satisfied with a received product, she is able to return it at any point of sale in the retail network without having to package the product for mailing it back to a vendor.

Moreover, the flexible nature of the retail network of the present invention enables retailers to meet customers' demand without having to stock retail stores with excessive amount of products.

Accordingly, storage, transportation, labor and real estate-relates expenses of retail operations may be substantially reduced. Due to cost savings, the retail network of the present invention makes it possible to reduce price of goods offered for sale.

Those skilled in the art will recognize that the present invention admits of a number of modifications, within the spirit and scope of the inventive concepts. For instance, the invention may be implemented in a number of different ways. For example, servers for carrying out various protocols in the retail network may be implemented using general-purpose digital signal processors and appropriate programming, or using specifically engineered chips having logic circuits and other components for performing the functions described above. Moreover, these functions may be performed by local computer devices associated with various points of the network, such as district, regional and specialty nodes and points of sales. Alternatively, functions of the servers may be distributed among multiple computer devices associated with different points of the network.

While the foregoing has described what are considered to be preferred embodiments of the invention it is understood that various modifications may be made therein and that the invention may be implemented in various forms and embodiments, and that it may be applied in numerous applications, only some of which have been described herein. It is intended by the following claims to claim all such modifications and variations which fall within the true scope of the invention.

1. In a system for processing orders supported by multiple retail networks and comprising a client terminal for sending a request providing indication of an item being purchased and indication of a point of sale selected for delivery of the item, together with an identifier of a purchaser:
a server configured for receiving the request and enabling the purchaser to locate a retail network node at which the requested item is available, the node being provided outside a local retail network corresponding to the point of sale selected for delivery, a path being arranged for routing the item from the node to the selected point of sale.

2. In a retail network comprising at least one district network including a district node and multiple regional networks, each having a regional node and multiple points of sale, a system for processing orders received from a client terminal capable of sending a request providing indication of an item being purchased and indication of a point of sale selected for delivery of the item, together with an identifier of a purchaser, the system comprising:
a first server associated with a selected node of the retail network located outside a regional network having the point of sale selected for delivery, and configured for receiving the request if the item is not available in the regional network, the first server being further configured for arranging a delivery path for delivery the item from the selected node to the selected point of sale.

3. The system of claim 2, wherein the first server is configured for routing the delivery path via the regional node of the regional network.

4. The system of claim 3, wherein the first server is configured for routing the delivery path via the district node.

5. The system of claim 4, wherein the first server is configured for scheduling delivery of the item from the selected node to the district node.

6. The system of claim 5, wherein the first server is further configured for scheduling delivery of the item from the district node to the regional node.

7. The system of claim 6, wherein the first server is further configured for scheduling delivery of the item from the regional node to the selected point of sale.

8. The system of claim 4, comprising a second server configured for arranging a return path for return of an item returned by a customer from a point of sale selected by the customer for return to a selected node.

9. The system of claim 8, wherein the second server is configured for routing the return path via the regional node.

10. The system of claim 9, wherein the second server is configured for routing the return path via the district node.

11. The system of claim 2, wherein the regional node is configured for being supplied with merchandise purchased from a vendor in a region covered by the regional retail network corresponding to the regional node.

12. The system of claim 11, wherein the regional node is controlled to arrange a purchased merchandise path from the regional node to a node selected for delivery of the purchased merchandise.

13. The system of claim 12, wherein the purchased merchandise path is routed via the district node.

14. The system of claim 2, wherein the district distribution node is configured to provide a two-directional transfer of goods between the regional node and selected node.

15. The system of claim 2, wherein the selected node is configured for storing products of a particular type.

16. In a retail network comprising at least one district network including a district node and multiple regional networks, each having a regional node and multiple points of sale, a method of processing orders received from a client terminal capable of sending a request providing indication of an item being purchased and indication of a point of sale selected for delivery of the item, together with an identifier of a purchaser, the method comprising the steps of:
configuring a selected node of the retail network located outside a regional network having the point of sale selected for delivery, for receiving the request if the item is not available in the regional network, and
controlling the selected node for arranging a delivery path from the selected node to the point of sale selected for delivery.

17. The method of claim 16, further comprising the step of routing the delivery path via the district node and the regional node of the regional network having the point of sale selected for delivery.

18. The method of claim 17, further comprising the step of arranging a return path from a point of sale selected for return of a delivered item to a selected node.

19. The method of claim 18, further comprising the step of routing the return path via the regional node and the district node.

20. The method of claim 16, further comprising the step of configuring the district node for providing a two-directional transfer of goods between the selected node and the regional node.

21. A retail network for enabling customers to pick up ordered goods at a selected point of sale, comprising:
at least one district network for providing retail operations within a district, the district network including multiple regional networks for providing retail operations within respective regions of the district, and at least one district distribution node for providing transfer of goods to the regional networks,
each of the regional networks including multiple points of sales and a regional distribution node responsive to customer's orders for supplying the ordered goods to the points of sales.

22. The retail network of claim 21, further comprising at least one specialty node for providing operations with a particular type of merchandise.

23. The retail network of claim 22, wherein said at least one district distribution node provides transfer of goods between said at least one specialty node and the regional networks.

24. The retail network of claim 23, wherein the goods transferred between said at least one specialty node and the regional networks include a retail stream of goods representing merchandise ordered by the customers and a wholesale stream of goods representing merchandise transferred to the regional distribution node to replenish stocks.

25. The retail network of claim 24, wherein the retail stream is assigned with priority higher than priority of the wholesale stream.

26. The retail network of claim 24, wherein the district distribution node has a routing mechanism for routing the wholesale stream transferred from the specialty node in accordance with a destination address identifying the regional distribution node.

27. The retail network of claim 24, wherein the district distribution node has a repackaging mechanism for removing goods ordered by a customer from a container packaged at the specialty node and packaging the goods into a container addressed to a regional network including a point of sale selected by the customer.

28. The retail network of claim 23, wherein the regional distribution node is configured for being supplied with merchandise purchased from a supplier within a respective region, and for being supplied by the district distribution node.

29. The retail network of claim 28, wherein a two-directional stream of goods is provided between the regional distribution node and the district distribution node.

30. The retail network of claim 28, wherein a two-directional stream of goods is provided between the regional distribution node and the specialty distribution node.

31. The retail network of claim 21, wherein multiple district networks are provided, and each of the district networks includes a gateway mechanism for providing transfer of goods between the district networks.

32. The retail network of claim 21, wherein the points of sale includes stationary points and mobile points.

33. The retail network of claim 21, wherein a point of sale includes a section for enabling the customers to pick up the ordered goods delivered from the respective regional node, and a section for selling merchandise available in stock.

34. A retail network for providing retail operations, comprising:
at least one district network for providing retail operations within a district, the district network including multiple regional networks for providing retail operations within respective regions of the district, and at least one district distribution node for providing transfer of goods between the regional networks, each of the regional networks including multiple points of sale and a regional distribution node for supplying the points of sales,
two-directional transfer of goods being provided between the regional distribution node and said at least one district distribution node.

35. The network of claim 34, further comprising at least one specialty node for providing retail operations with a particular type of merchandise.

36. The retail network of claim 35, wherein said at least one district distribution node provides two-directional transfer of goods between said at least one specialty node and the regional distribution node.

37. The retail network of claim 34, wherein multiple district networks are provided, the retail network further including a gateway mechanism for providing two-directional transfer of goods between the district networks.

38. The retail network of claim 34, wherein the district distribution node has a buffer mechanism for buffering selected items before delivery to regional distribution nodes.
